(19) United States
(12) Patent Application Publication
(10) Pub. No.: US 2014/0352825 A1
(43) Pub. Date: Dec. 4, 2014

(54) CONTROL VALVE WITH CONTACT SURFACE HARDENED END CAPS

(71) Applicant: International Engine Intellectual Property Company, Lisle, IL (US)

(72) Inventors: Robert Donald Roy, Lugoff, SC (US); Martin Heiner Luedicke, Columbia, SC (US)

(21) Appl. No.: 13/906,403

(22) Filed: May 31, 2013

(51) Int. Cl. F16K 1/44

(52) U.S. Cl. CPC F16K 1/44
USPC 137/625.34

(57) ABSTRACT

An end cap assembly configured for use in a control valve and in combination with a spool includes a stater, the stater having a spool stop having a hardened surface.

### BACKGROUND

Control valves may be used to control the flow of fluids, for example in fuel injectors designed to inject fuel into a combustion chamber of an engine. Fuel injectors may be mechanically, electrically or hydraulically controlled in order to inject fuel into the combustion chamber of the engine. In the hydraulically actuated systems, a valve control body may be provided with two, three or four way valve systems, each having grooves or orifices which allow fluid communication between working ports, high pressure ports and venting ports of the valve control body of the fuel injector and the inlet area. The working fluid is typically engine oil or other types of suitable hydraulic fluid that is capable of providing a pressure within the fuel injector in order to begin the process of injecting fuel into the combustion chamber.

The control valves of such fuel injectors include reciprocating spool between opposed end caps. The spool reciprocates between a closed position and an opened position. In the closed position, the spool is positioned such that no fluid flow is permitted. In the opened position, the spool is positioned such that the control valve permits passage of fluid through the valve.

In the closed position, one end of the spool is in contact with one of the end caps. When the valve is opened, the spool is repositioned such that it contacts the opposed end cap. The reciprocating action of the spool from the closed to opened positions and vice versa requires the spool to engage the opposed end caps repeatedly. This repeated engagement may cause substantial wear on the end caps. To address this wear, end caps have been through hardened. For end caps that operate as solenoids that exert the motive force on the spool, through hardening may diminish the magnetic characteristics of the end caps.

### SUMMARY

The disclosure addresses the issues of wear on the staters of end cap assemblies while maintaining adequate and acceptable magnetic characteristics of the staters.

### BRIEF DESCRIPTION OF THE DRAWINGS

FIG. 1 is a cross-sectional view of a control valve, including a control valve body, end cap assemblies and a spool.

FIG. 2 is an elevated view of an end cap assembly.

FIG. 3 is a cross-sectional view of an end cap assembly.

FIG. 4 shows the hardness profile of the surface hardened end cap assembly.

FIG. 5 is a graph comparing the magnetic forces generated in a surface hardened stater of an end cap assembly and a through hardened stater of an end cap assembly at a 0.2 mm air gap.

FIG. 6 is a graph comparing the magnetic forces generated in a surface hardened stater of an end cap assembly and a through hardened stater of an end cap assembly at a 0.3 mm air gap.

FIG. 7 is a graph comparing the magnetic forces generated in a surface hardened stater of an end cap assembly and a through hardened stater of an end cap assembly at a 0.4 mm air gap.

FIG. 8 is a graph comparing the magnetic forces generated in a surface hardened stater of an end cap assembly and a through hardened stater of an end cap assembly at a 0.5 mm air gap.

### DETAILED DESCRIPTION

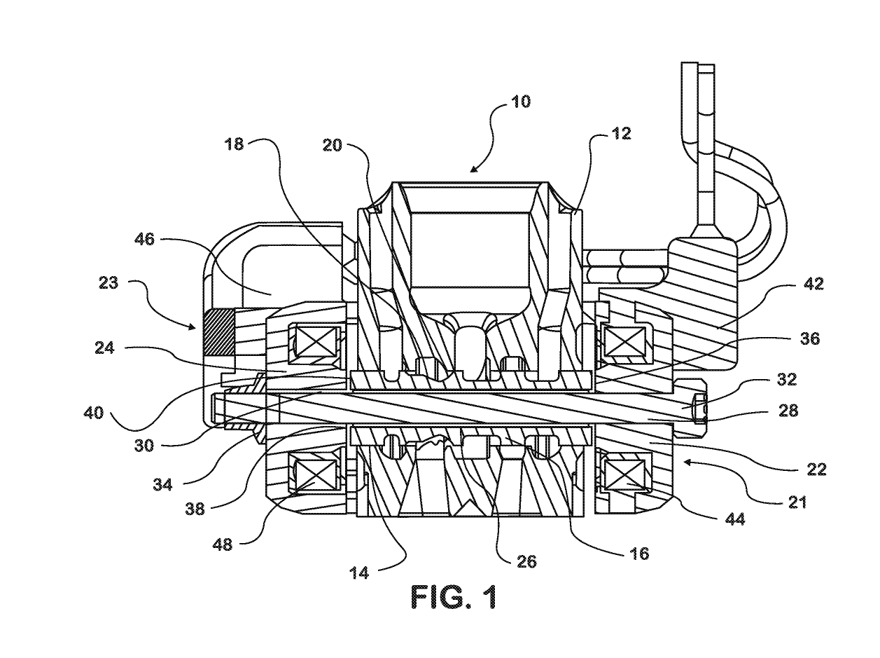

FIG. 1 shows a cross sectional view of a control valve assembly 10. The control valve assembly 10 includes the control valve 12. The control valve 12 has a passage 14 to accommodate a spool 16. The passage 14 if configured such that spool 16 may slidably engage the passage 14.

The spool includes at least one spool groove 18. The control valve includes at least one control valve groove 20. The spool 16 slidably engages the passage 14 such that in an open position, the spool groove 18 cooperates with the control valve groove 20 such that fluid is permitted to flow through the control valve 12.

The spool 16 is retained within the passage 14 by an open end cap assembly 21 and a close end cap assembly 23.

The open end cap assembly 21 includes an open stater 22, which has an open stater passage 28. The close end cap assembly 23 includes a close stater 24, which has a close stater passage 30 and the spool includes a spool passage 26. Each of these passages 26, 28, 30 is adapted to receive a screw 32. The screw 32 is fixed in place by nut 34.

When the control valve 12 is assembled, the screw 32 is passed through the open stater passage 28, the spool passage 26, and the close stater passage 30. The nut 34 engages with screw 32 adjacent the close stater 24 to hold all of the components in place.

The open stater 22 defines a first spool stop 36. The closed stater 24 defines a second spool stop 38. As shown in FIG. 1, the control valve 12 is in its open position where spool 16 abuts the first spool stop 36 of open stater 22. In this position, spacing 40 exists between spool 16 and second spool stop 38 of close stater 24. When the spool 16 is moved to a closed position, spool 16 abuts second spool stop 38 of close stater 24. The spool 16 is driven from an open position to a closed position and vice versa by the magnetic forces generated in open stater 22 and close stater 24. In particular, a magnetic force can be generated in open stater 22 in a conventional manner as shown by open coil 42 and open windings 44. To place control valve 12 in an open position, a magnetic force is created in open stater 22. This magnetic force attracts spool 16 such that spool 16 abuts first spool stop 36. In this open position spool groove 18 will cooperate with control valve groove 20 to permit passage of fluid through the control valve 12.

To place control valve 12 in a closed position, a magnetic force is created in close stater 24 in a typical fashion as shown by closed coil 46 and closed windings 48.

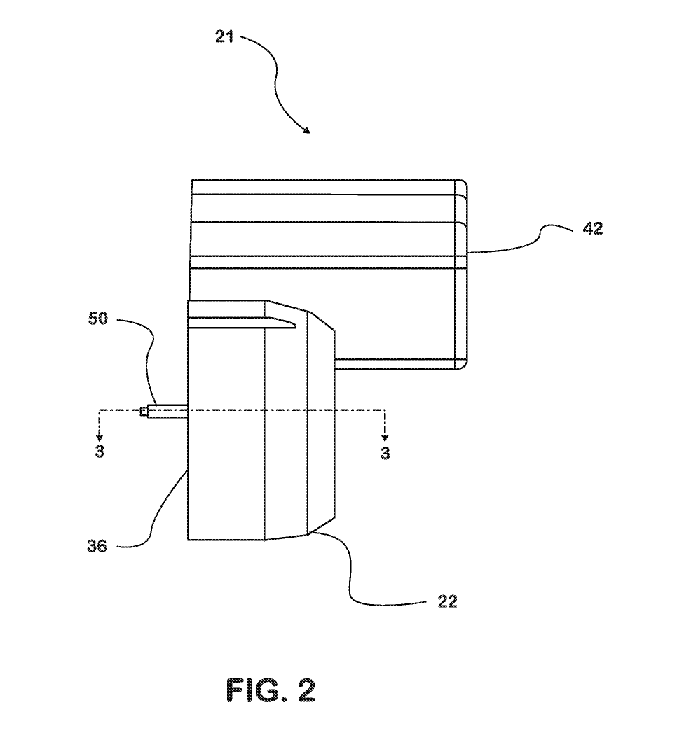

FIG. 2 is an elevated view of open end cap assembly 21, which has open stater 22, open coil 42 and an optional alignment pin 50 that may be used to properly align open end cap assembly 21 on the control valve assembly 10. Open stater 22 may be made of material capable of generating a magnetic force when subjected to an electrical current. Typical materials include magnetic steel such as SAE 4140, 4142, or 4145. When open stater 22 is subjected to an electrical current, it exerts a magnetic force on spool 16 (FIG. 1) biasing spool 16 toward first spool stop 36. In this position, spool groove 18 (FIG. 1) cooperates with control valve groove 20 to permit flow through control valve 12.

Referring to FIG. 1, because of the repeated impact of spool 16 with first spool stop 36 of open stater 22 and also second spool stop 38 of close stater 24, first spool stop 36 and second spool stop 38 may be surface hardened. Such surface hardening enables open stater 22 and close stater 24 to maintain acceptable magnetic characteristics throughout, yet provides a durable impact surface that can withstand the repeated impacts associated with the activation of the spool 16 in the normal operation of control valve 12.

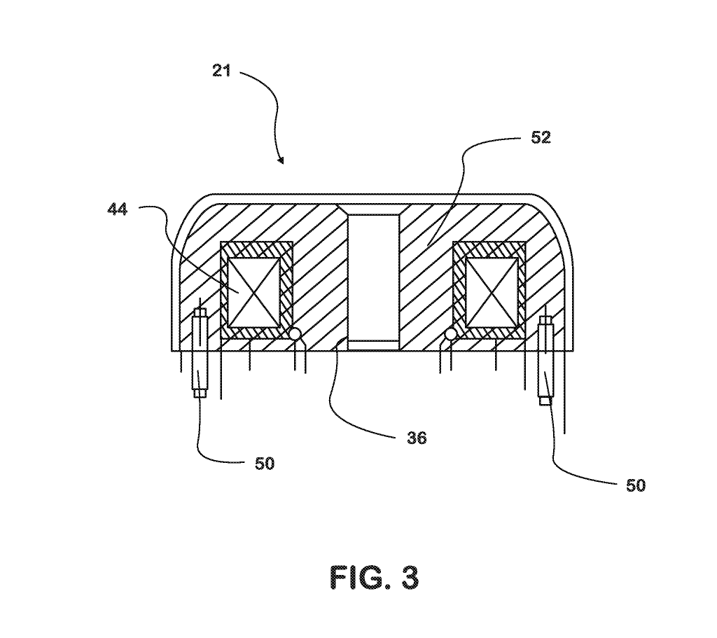

FIG. 3 is a cross-sectional view of open end cap assembly 21. Open end cap assembly 21 includes within it open windings 44. Also shown, alignment pins 50 can be optionally placed at opposed ends of the open end cap assembly 21. First spool stop 36 provides the impact surface for contact with spool 16 and is the only surface of open stater 22 that requires surface hardening to tolerate the repeated impact. Stater core material 52 need not be hardened. In this way, the stater core material 52 may retain the magnetic characteristics of the unhardened magnetic steel to be used.

The hardening of first spool stop 36 and second spool stop 38 may be accomplished in any number of methods such as induction hardening, laser hardening, and flame hardening. The surface hardening achieved by these methods is adequate to provide the surface hardness required to withstand the repeated impacts to which the open stater 22 and closed stater 24 are subjected.

### EXAMPLE 1

A stater made of SAE 4140 steel was induction hardened at its spool stop surface, such as described above at first spool stop 36 and second spool stop 38 (FIG. 1). The induction hardening was accomplished at a typical frequency used for hardening such materials. One such typical frequency for this material considering the depth of the hardened case is 46 kHz at 15 kWs.

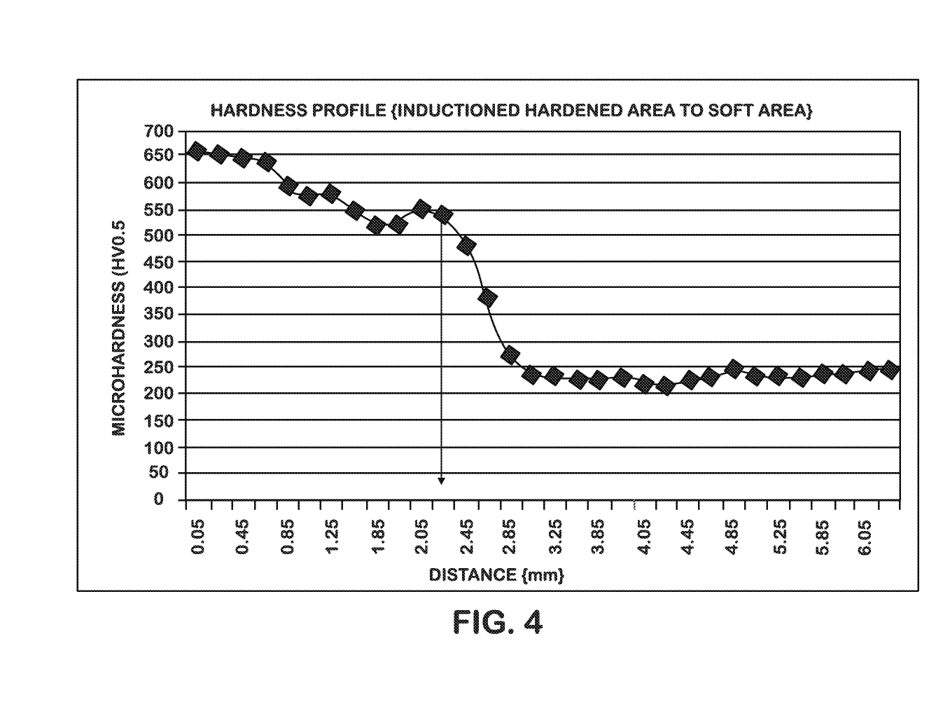

FIG. 4 shows the hardness profile of the surface hardened stater. As shown in FIG. 4, the induction hardening resulted in a hardening of the steel to a depth of about 2.3 mm. The hardness profile reflects that the hardness of the stater decreases to a depth of about 3.0 mm. The hardness of the unhardened main body of the stater made of SAE 4140 material is then reflected as about 200-250 HV0.5 hardness. (When the term “about” is used in connection with a range, it is meant to apply to both values of the range.)

### EXAMPLE 2

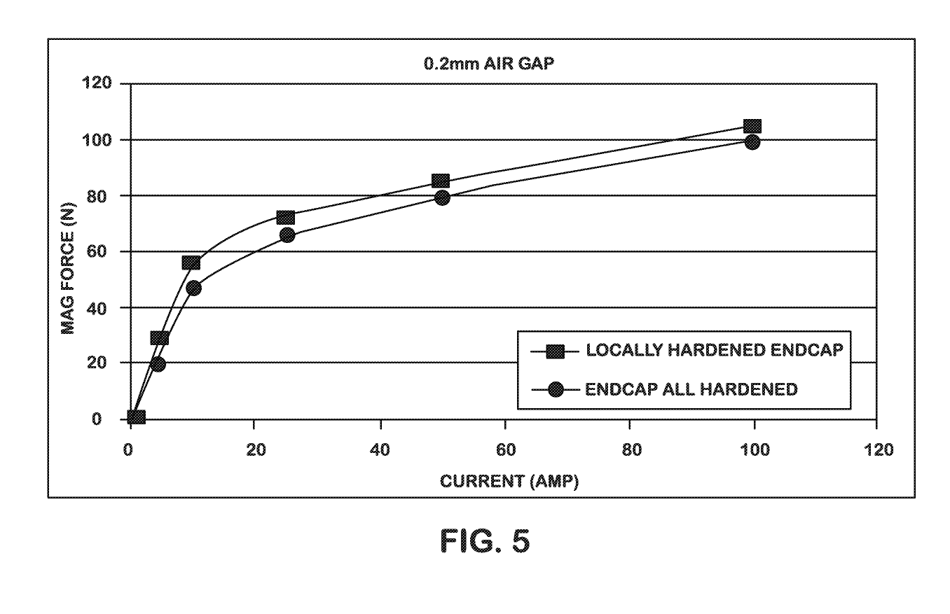

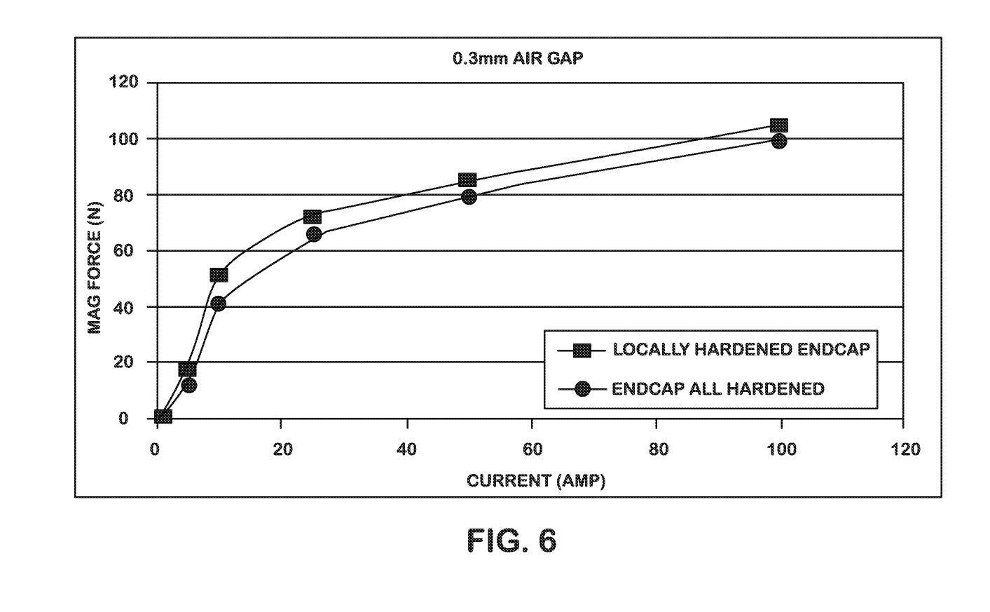

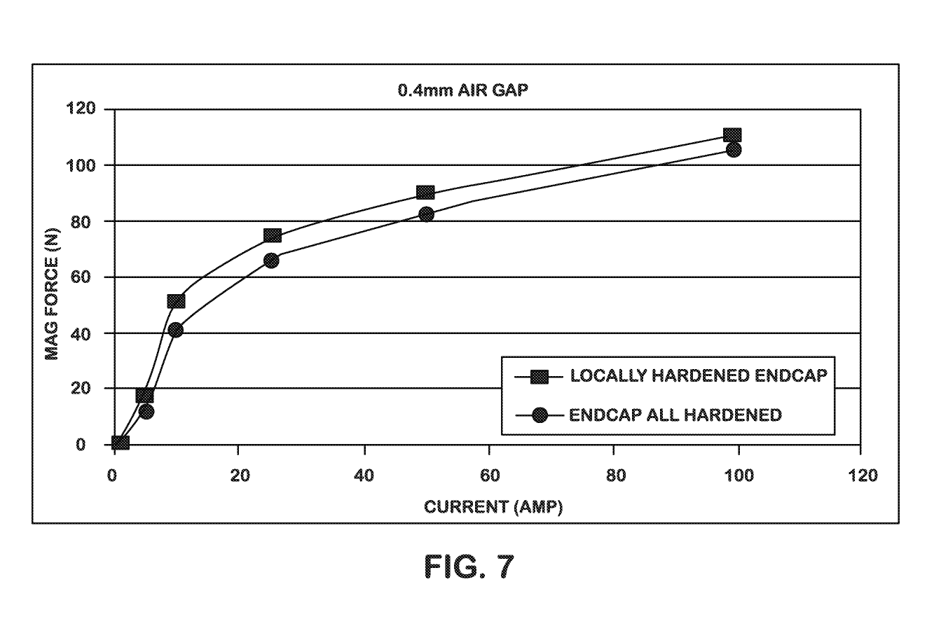

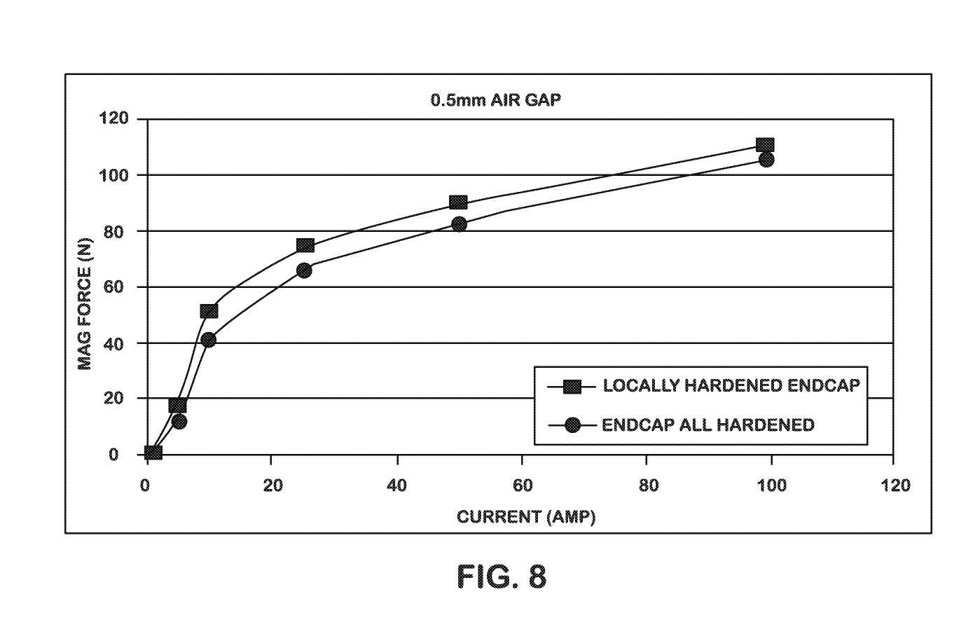

The stater of Example 1 was subjected to magnetic analysis. As a comparison, a stater that was through hardened in a typical fashion was used. FIGS. 5-8 are graphs comparing the magnetic forces generated in a surface hardened stater of an end cap assembly and a through hardened stater of an end cap assembly at different air gaps. FIGS. 5-8 show the improved magnetic force generated in the surface hardened stater as compared with the through hardened stater. The pull force associated with the surface hardened stater provides the pull required when used with a conventional spool 16 within a conventional control valve 12.

A material change from SAE 4140 to SAE 4142 or SAE 4145 (0.02% to 0.05 increase in nominal carbon) will yield higher average hardness with likely no appreciable detriment to magnetic properties.

For staters that are surface hardened using induction hardening, to further improve the magnetic compliance (or reduce magnetic resistance) of the surface hardened stater, the inductively hardened surface could be reduced to 0.1 or 0.2 mm. This reduced depth can be accomplished by increasing the frequency (Hertz) while simultaneously reducing the power (Watts) on the inducting coil. The higher frequency will allow for shallower penetration of the inductance, which will also increase the Joules/volume (hence the lower power).

1. A control valve comprising:
a first end cap assembly arranged on a first side of the control valve and comprising a first stater having a first spool stop, the first stater having a first hardened surface at the first spool stop;
a second end cap assembly arranged on a second side of the control valve and comprising a second stater having a second spool stop, the second stater having a second hardened surface at the second spool stop;
a spool slidably disposed within the control valve;
the spool comprising a first contact surface facing the first spool stop and a second contact surface facing the second spool stop, the spool configured to slide between the first and second spool stops.

2. The control valve of claim 1 wherein the first stater and the second stater are made of a magnetic steal selected from the group consisting of SAE 4140 steel, SAE 4142 steel, and SAE 4145 steel.

3. The control valve of claim 2 wherein the first stater and the second stater are made of SAE 4140 steel having a hardness of about 200-250 HV0.5

4. The control valve of claim 3 wherein the first hardened surface and the second hardened surface have a hardness of about 450-700 HV0.5.

5. The control valve of claim 4 wherein the first hardened surface and the second hardened surface have a thickness of about 0.1-2.5 mm.

6. The control valve of claim 3 wherein the first hardened surface and the second hardened surface have a hardness of about 662 HV0.5.

7. The control valve of claim 6 wherein the first hardened surface and the second hardened surface have a thickness of about 0.1-1.0 mm.

8. An end cap assembly configured for use in a control valve and in combination with a spool comprising:
a stater, the stater having a spool stop, the spool stop having a hardened surface.

9. The end cap assembly of claim 8 wherein the stater is made of a magnetic steal selected from the group consisting of SAE 4140 steel, SAE 4142 steel, and SAE 4145 steel.

10. The end cap assembly of claim 9 wherein the stater is made of SAE 4140 steel having a hardness of about 200-250 HV0.5

11. The end cap assembly of claim 10 wherein the hardened surface has a hardness of about 450-700 HV0.5.

12. The end cap assembly of claim 11 wherein the hardened surface has a thickness of about 0.1-2.5 mm.

13. The end cap assembly of claim 10 wherein the hardened surface has a hardness of about 662 HV0.5.

14. The end cap assembly of claim 13 wherein the hardened surface has a thickness of about 0.1-1.0 mm.

15. The end cap assembly of claim 8 wherein the stater has a main body and the hardened surface has a hardness of about 180-350% harder than the main body.
